(19) United States
(12) Patent Application Publication
(10) Pub. No.: US 2024/0238865 A1
(43) Pub. Date: Jul. 18, 2024

(54) 3D PRINTING METHOD AND MOLDING PART PRODUCED THEREWITH USING A WATER GLASS BINDER AND ESTER

(71) Applicant: Voxeljet AG, Friedberg (DE)

(72) Inventors: Ingo EDERER, Geltendorf (DE); Roman SCHELLER, Mering (DE); Massimo RUSSO, Mering (DE)

(21) Appl. No.: 18/562,485

(22) PCT Filed: May 19, 2022
(86) PCT No.: PCT/DE2022/000055

§ 371 Date: Nov. 20, 2023

(30) Foreign Application Priority Data
May 28, 2021 (DE) 10 2021 002 770.1

(51) Int. Cl. B22C 1/18; B22C 9/02; B22F 10/14; B22F 10/64; B28B 1/00; B33Y 10/00; B33Y 70/10; B33Y 80/00; C04B 14/06; C04B 24/04; C04B 24/16; C04B 28/00; C04B 103/40; C04B 111/00; C04B 111/20

(52) U.S. Cl. CPC B22C 1/188; B22C 9/02; B22F 10/14; B22F 10/64; B28B 1/001; B33Y 10/00; B33Y 70/10; B33Y 80/00; C04B 14/06; C04B 24/045; C04B 24/16; C04B 28/008; C04B 2103/402; C04B 2111/00181; C04B 2111/2084

(57) ABSTRACT

Material system suitable for a 3D printing method or 3D printing method material system comprising or consisting of a particulate material, a printing liquid, and an ester activator as well as 3D printing processes that use such a material system and molding parts produced by means of such material systems and 3D printing processes.

### CLAIM OF PRIORITY

This application is a national phase filing under 35 USC § 371 from PCT Patent Application serial number PCT/DE2022/000055 filed on May 19, 2022 and claim priority therefrom. This application further claims priority to German Patent Application Number DE 102021002770.1 filed on May 28, 2021. International Patent Application number PCT/DE2022/000055 and German Patent Application number DE 102021002770.1 are each incorporated herein by reference in its entirety.

### FIELD

The present invention relates to a material system for 3D printing, to a 3D printing method using a binder based on water glass, an activator based on ester on molding parts that are produced by means of powder-based layer construction methods and the use of the molding parts.

### BACKGROUND

European patent EP 0 431 924 B1 describes a method for producing three-dimensional objects from computer data. A particulate material is applied in a thin layer to a platform and this is selectively printed using a liquid by means of a print head. In the area printed using the liquid, the particles bond and the area solidifies under the influence of the liquid and possibly an additional hardener. The platform is then lowered by a layer thickness in a construction cylinder and provided with a new layer of particulate material, which is also printed as described above. These steps are repeated until the object reaches a certain desired height. A three-dimensional object thus results from the printed and solidified areas.

One advantage here is that part of the component material is already provided by the volume of the particulate material. The amount that has to be metered in liquid by means of a printer is comparatively small. This method allows high print head speeds, short layering times, and a—comparatively—simple print head structure.

The particulate material is solidified here by adhesive bonding of the individual particles with one another.

This method can be used to process various particulate materials, including—but not limited to—natural biological raw materials, polymeric plastics, metals, ceramics, and sand.

Sand particles, for example, can be processed using binder systems by powder-based 3D printing. This includes, among other things, cold resin bonding, which is used in the foundry industry as well as in 3D printing.

Inorganic binders are also used in this area. These are the environmentally friendly alternative to cold resin binders in the foundry industry.

These materials are particularly suitable for metal casting, which usually involves high temperatures and wherein a large part of the organic binder burns and weakens the mold. In the next step, after the melt has cooled, the mold residues are removed mechanically. With inorganically bound casting molds, high energy has to be applied to prevent the mold from not weakening during casting.

Inorganic binder systems have been used in metal casting since the middle of the last century to produce sand molds.

For example, so-called hydraulic binders are to be mentioned here, i.e., binders that harden both in air and under water.

This includes, for example, plaster-bound molding materials. Particulate material containing plaster, for example, is used to produce casting molds. The plaster contained in the particulate material is activated using an aqueous solution and hardens selectively, for example. The mold has to be dried after the printing.

After production, the plaster contains a large amount of free water, which can result in problems when casting because it can suddenly evaporate when heated.

Furthermore, it has been shown that the strength of the plaster is not particularly high and the temperature resistance of the plaster only allows a light metal casting for the resulting molds. Furthermore, it has been shown that the plaster is very dense when hardened and is only permeable with difficulty to gases that can arise during casting, because of which the gases can penetrate into the casting melt.

In addition, cement-bound molding materials are also known; reference is to be made to DE 10 2004 014 806 B4 and EP 1 510 310 A2 as examples.

There is cement in the sand for the casting mold here and the cement is activated via an aqueous ink.

The disadvantage here is that cements generally develop higher strengths when tempered, which they then retain even after they have cooled down. This means that it is difficult to remove the molding material from the cast part after casting.

In addition, excess water can also again result in problems when casting here. Therefore the mold has to be dried before casting.

Furthermore, it may also be the case that the grain distribution of reactive cements is a problem with the layer generation devices commonly used in 3D printing. The cements often have poor flow properties and tend to form agglomerates. The result is poor surfaces and component defects. The fine grain also creates unpleasant dust. The unbound powder in the construction container is highly alkaline and therefore unfriendly to the skin.

In addition to hydraulic binders, so-called crystal formers are also known for use for molding materials.

This includes, for example, salt-bonded molding materials, wherein sands can be mixed or coated using salts and the particulate material is printed using a solvent—usually an aqueous solution. The salt dissolves and forms bridges between the particles. If the mold is then dried, the water escapes and the bond becomes solid.

Salt-bound moulding materials have the advantage that they can be removed “wet” after the casting by immersing the cast parts in a water bath. The salt dissolves, the sand loses its bond and can be rinsed out.

However, after drying, water components are bound in the salt, which can be released when the mold is cast, which can result in the gas problems mentioned above.

In addition, the dimensional stability of the kernels is relatively low, since the salt tends to absorb moisture from the air and softens in the process.

Drying after printing has to be controlled precisely, as excessive drying in turn results in loss of binding. Insufficient drying in turn results in gas problems during casting.

The salts in the sand are often aggressive towards metals, so materials that come into contact with the sand have to be passivated accordingly.

The use of cement, plaster, and salt-bound molding material mixtures is of no significant importance in series casting, in particular in automobile casting.

In addition, it using water glass as a binder for the production of foundry molds is also generally known.

A method for producing a molding part from a casting mold for casting metal melts is known from EP 2 163 328 A1, for example, which comprises providing a core or molding sand comprising a molding base material, coated with water glass and a water content in the range of >=approximately 0.25% by weight to approximately 0.9% by weight, in relation to the total weight of the core and molding sand, filling the core or molding sand into a cavity depicting the molding part, and bringing the core or molding sand into contact with at least one curing agent before, during, and/or after filling and solidifying the molding part.

The use of water glass in the foundry industry is generally known. Water glass binders are used for mold and core production in series casting. Curing can take place in a cold tool via reaction with carbon dioxide gas (CO2 gas) or reaction with an ester.

In addition, in recent years the curing of water glass bonded molding material mixtures by way of hot tools has become established, analogous to the organic hot box process and the combined curing by way of heated tools and gassing with, usually heated, air.

Core production by means of water glass and esters or CO2 gas is odorless and is therefore much more environmentally compatible than the use of organic binders such as furan, phenol resins, or polyurethane resins.

In additive manufacturing, the positive aspects of inorganic binders could only be partially implemented. On the one hand, this is due to the less good metering ability of water glass-based binders and also to the need for complex post-processes.

DE102011105688 discloses a material system for a binder jetting method which consists of a molding sand into which spray-dried water glass particles are mixed. The molding sand mixture is applied in layers and selectively printed with an alkali silicate solution. The alkali silicate solution partially dissolves the dried water glass, which then in turn binds the molding sand particles while it dries. The disadvantage of this technique is the relatively low strength that results between the particles. In addition, a relatively large amount of liquid has to be imprinted in order to effectuate the dissolution of the dried water glass. This amount of liquid travels into non-printed areas due to gravity and capillary action and thus influences the dimensional accuracy. In addition, the amount of liquid has to be removed again by drying.

Water glass binders are now also known which, with respect to viscosity and drying behavior at the open nozzle, allow printability in the binder jetting process.

However, areas printed with these binders only achieve the necessary strength when exposed to certain temperatures in the range of 100-150° C. for a certain exposure time. In addition, the water in the binder, which is also necessary as a solvent to achieve printability, has to be reduced in order to achieve full strength. Last but not least, an excessive water content in the particulate material would result in problems when casting with metals if the water then evaporates in large quantities in contact with the liquid melt.

The heating and drying of the binder cannot take place during the layer application, as the exposure time to the temperature would be too short for the strength to develop and the binding effect would decrease significantly from layer to layer. This means that particulate material beds printed using such binders have to be heated and dried after the layer application has been completed. This can be carried out in suitable circulating air ovens, which takes a relatively long time when using corresponding poorly heat-conducting powder materials such as quartz sand and larger construction volumes. For example, a full construction box of a commercially available VX1000 3D printer from voxeljet would require approximately 24 hours of warm-up time in a circulating air furnace with a temperature set at 120° C. in order to heat quartz sand from a room temperature of 20° C. in the interior of the construction box to 115° C.

An alternative possibility is to use suitable microwave ovens, which, due to their mode of operation, can directly heat the printed areas in the interior of the particulate material bed in a short time.

The disadvantage of this method is the need for complex oven technology. Microwave ovens of the appropriate size are not commercially available, but have to be individually designed and manufactured. They are also relatively expensive.

The object of the invention is therefore to provide, in various aspects, a method and a material system for the layered construction of molds and cores, which does not have the disadvantages of known methods or at least reduces or completely overcomes the disadvantages of the prior art, for example is environmentally compatible and is usable economically for three-dimensional printing methods.

### BRIEF SUMMARY OF THE INVENTION

In one aspect, the invention relates to a material system comprising a particulate material, a printing liquid comprising a binder, and an ester activator.

In a further aspect, the invention relates to a 3D printing method for producing molding parts that can be used for casting molds and cores and as models.

In a further aspect, the invention relates to a molding part that was produced by means of a material system and/or 3D printing method disclosed here.

### DETAILED DESCRIPTION OF THE INVENTION

In one aspect, the solution to the problem underlying the application relates to a material system comprising a particulate material, a printing liquid comprising a binder, and an ester activator.

A material system according to the invention offers, among other things, the advantage that it is cost-effective, since either inexpensive insoluble materials can be used and/or the insoluble particulate material can essentially be reused. This is particularly advantageous for expensive particulate materials.

In a preferred aspect, the invention is directed to a material system, wherein the particulate material is selected from the group consisting of at least one inorganic particulate material and/or at least one organic particulate material, wherein the inorganic particulate material is preferably a quartz sand, an olivine sand, a kerphalite, a Cerabeads, a ceramic, and/or a metal powder and the organic particulate material is preferably a wood powder, a starch powder, and/or a cellulose powder and the printing liquid comprises or consists of a liquid selected from the group consisting of water glass or an aqueous solution comprising water glass and the ester activator consists of or comprises one or more condensates of monovalent or polyvalent alcohols and monovalent or polyvalent organic carboxylic acids, such as formic and/or acetic acid, or dimethyl adipate, diethyl glutarate, triacetin, dimethyl succinate, or mixtures of various esters, preferably having a vapor pressure <1 hPa, preferably wherein the particulate material is mixed with an ester activator and optionally with a solid promoter, preferably wherein the ester activator is mixed into the particulate material with an addition of 0.2-1% by volume, preferably wherein the particulate material has an average grain size of 0.02-0.5 mm, preferably wherein the ratio of printing liquid to ester activator is between 8 and 12, preferably wherein the printing liquid also comprises surfactants, such as sodium dodecyl sulfate or Surfynol 465 and has the surface tension of 20 mN/m-50 mN/m, preferably 25 mN/m-40 mN/m, and particularly preferably of 28 mN/m-35 mN/m, and/or comprises defoamer from, for example, the group of siloxanes and/or comprises colorants and/or alkali metal hydroxides for adjusting the pH value.

In a further aspect, the invention is directed to a 3D printing method for producing a molding body comprising the steps of applying a particulate material mixture to a construction level, selectively applying a printing liquid, wherein the printing liquid comprises or consists of a liquid selected from the group consisting of water or a aqueous solution and a water glass-containing component or derivatives thereof for at least partial selective solidification, optionally controlling the temperature of the construction field or energy input into the applied particulate material mixture, preferably controlling the temperature to 20° C. to 60° C., and the printing liquid, repeating these steps until the desired molding part was obtained, preferably wherein the printing liquid is metered into the particulate material with an addition of 2-10% by volume.

In a preferred aspect, the invention relates to a 3D printing method, wherein the molding part obtained is separated from the non-solidified particulate material and the molding part is preferably subjected to a further heat treatment step and/or a treatment using microwave radiation and/or wherein the particulate material is applied by means of a coater (recoater) and/or wherein the printing liquid is selectively applied using a print head and/or wherein the molding part is left in a powder bed at ambient conditions for 1 hour to 24 hours after the printing method has been completed.

Furthermore, it is preferred in the 3D printing method according to the invention that the molding part is dried and/or hardened by suctioning a gas or gas mixture, preferably ambient air, through the entirety of non-printed and printed areas after the printing method has been completed, wherein preferably this suctioning through takes place 0 hours-24 hours, preferably 0 hours-12 hours, particularly preferably directly after the end of printing, preferably suctioning through takes place for 0.5 to 5 hours and preferably the molding part has a strength of 150 N/cm² to 200 N/cm².

In a further preferred aspect, the invention relates to a 3D printing method as described herein, wherein in an additional step the molding part is subjected to a treatment using microwave radiation, wherein preferably the treatment takes place over a period of time of 2 minutes-30 minutes, preferably 2 minutes-15 minutes, particularly preferably 2 minutes-10 minutes, and/or wherein the surface of the molding part is furthermore coated or sealed.

In a further aspect of the invention, a material system as described herein is used in a 3D printing method described herein.

In a further aspect of the invention, the invention relates to a molding part produced using a material system or 3D printing method as described herein, preferably wherein the residual moisture in the printed molding part is 0.3-1.0% by weight and/or the molding part has strengths of 80 N/cm²-150 N/cm², preferably 200 N/cm², in the printing direction.

In a further aspect of the invention, the invention relates to a molding part produced by means of 3D printing methods as described herein, wherein the molding part is left for 4 hours-24 hours, preferably 8 hours-15 hours, particularly preferably 10 hours-11 hours, at ambient conditions in the powder bed.

Finally, the invention relates to the use of a material system as described herein in a 3D printing method, or the use of a molding part produced according to a method as described herein for metal casting, cold casting of synthetic resins or hydraulically setting systems, or as a laminating mold.

Furthermore, the material system and the 3D printing system according to the disclosure can be characterized as follows:

In a material system according to the invention, the relationship between the individual components is adjusted in such a way that a 3D printing method can be carried out advantageously and results in the desired properties of the produced molding parts.

In a further aspect, the material system according to the invention is characterized in that the printing liquid consists of or comprises a water glass.

In a material system according to the invention, the printing liquid is adjusted in a suitable manner with regard to its viscosity using suitable substances or liquids known to those skilled in the art. The viscosity can be between 2 mPas-20 mPas, preferably between 8 mPas-15 mPas and particularly preferably between 10 mPas-14 mPas.

In a material system according to the invention, the printing liquid can furthermore comprise surfactants such as sodium dodecyl sulfate or sodium laureth sulfate and have a surface tension of 20 mN/m-50 mN/m, preferably 25 mN/m-40 mN/m and particularly preferably 28 mN/m-35 mN/m, and/or defoamers from, for example, the group of siloxanes and/or colorants.

In a further aspect, the invention relates to a 3D printing method for producing a molding body comprising the steps of applying a particulate material mixture to a construction level, selectively applying a printing liquid, wherein the printing liquid comprises or consists of a liquid consisting of a water glass, a solvent, and optionally further components, for at least partial selective solidification, optionally controlling the temperature of the construction field or energy input into the applied particulate material mixture, preferably controlling the temperature to 30° C. to 60° C., more preferably 40° C. to 50° C., repeating these steps until the desired molding part has been obtained.

The advantage is that this method can be used to produce good quality molding parts and these can be used in different applications and uses.

In particular it is advantageous that the molding parts produced in this way (also mold or casting mold) can be used as casting molds or casting cores or for all purposes in which the mold is to be removed again at the end of the process for which it is used, for example via a dissolution process in water.

In a 3D printing method according to the invention, the molding part obtained can be separated from the non-solidified particulate material mixture and the molding part can optionally be subjected to a further heat treatment step.

As in all common 3D printing methods, such as inkjet methods, the particulate material mixture is applied by means of a recoater and, if necessary, the particulate material mixture is mixed together before application.

As in all common 3D printing methods, such as inkjet methods, the printing liquid is selectively applied using a print head.

In a 3D printing method according to the invention, the molding part can be left in the powder bed at ambient conditions for 4 hours-24 hours, preferably 8 hours-15 hours, particularly preferably 10 hours-11 hours, after completion of the printing method.

The 3D printing method according to the invention can be followed by further work steps. For example, in an additional step, the molding part is subjected to a heat treatment, preferably the molding part is stored for 1 hours-7 hours, preferably 4 hours-6 hours, at 30° C.-160° C., preferably at 50° C.-140° C.

In the 3D printing method according to the invention, air can be suctioned through the printed and unprinted construction volume to increase the unpacking strength. Suctioning through is preferably started immediately after or up to 8 hours after the end of mold production (end of job). The air suctioned through can have a temperature changed from room temperature, wherein the air suctioned through preferably has a temperature of 10° C.-80° C., preferably 15° C.-60° C., particularly preferably 20° C.-40° C. The duration of the suctioning through depends on the height and the quantity of printed parts and is, for example, between 4 and 16 hours for a height of 300 mm. The duration of the suctioning through determines the residual moisture and the finishability of the molding parts. The longer the process can take, the lower the residual moisture and better the finishability. A downstream heating process of the components in the furnace can still take place in order to further reduce the residual moisture. The molding part is preferably stored for 1 hour-7 hours, preferably 4 hours-6 hours, at 30° C.-160° C., preferably at 50° C.-140° C. The post-treatment can also be carried out using microwave radiation additionally to or as a replacement for the heat treatment in the furnace, wherein the treatment takes place over a period of time of 2 minutes-30 minutes, preferably 2 minutes-15 minutes, particularly preferably 2 minutes-10 minutes.

Another possibility for a subsequent step in a 3D printing method according to the invention is to further coat or seal the surface of the molding part, wherein all methods and materials known to those skilled in the art for such molding parts can be used.

The molding parts produced using the 3D printing method according to the invention can be used in a variety of applications, but preferably in metal casting methods or in lamination methods.

The material properties of the molding parts produced using the 3D method according to the invention are advantageous and can be further influenced in certain material properties by suitable subsequent steps of the process. For example, on the one hand, the strength can be influenced by the amount of solvent in the printing liquid and the amount of printing liquid applied to the particulate material; on the other hand, the strength can be adjusted by leaving the molding part in the powder bed or a subsequent heat treatment, as well as by suctioning through air. A molding part that is left in the powder bed at ambient conditions for 4 hours-24 hours, preferably 8 hours-15 hours, particularly preferably 10 hours-11 hours, can have strengths of 80 N/cm²-150 N/cm² in the printing direction. The strength is already achieved after a shorter time by suctioning through air.

In a further aspect, the invention relates to the use of a molding part produced according to the invention or a molding part produced by a method according to the invention for metal casting or as a laminating mold.

Further aspects of the invention are described hereinafter.

Before the actual 3D printing method according to the invention, the inert particulate material such as quartz sand, olivine sand, kerphalite or Cerabeads, but also insoluble plastics, has to be mixed with the ester-containing component.

For this purpose, a suitable mixing device is used, such as a compulsory mixer such as that used to provide organically bound molding materials. Such a mixer can be operated batch-based or continuously. In the mixer, a predetermined amount of the ester-containing component is supplied to the particulate material used and mixed. When using quartz sand as particulate material, the amount ratios are in a range of 0.1-0.8% by weight. For other particulate materials having different bulk density, the addition amounts have to be adjusted according to the difference in bulk density.

The advantage of the particulate materials mentioned is that no changes to the existing coater technology are necessary and standard 3D printers can be used that are able to process particulate material using furan resin, phenolic resin, and inorganic methods.

In the case of mixtures of particulate materials, the particle sizes are preferably between 90 μm and 250 μm, wherein finer powders are also suitable. This largely prevents unmixing during the transport of the particulate material.

Mixed powders are usually already homogenized upstream of the process in a discontinuous mixer.

The liquid second component, i.e., a printing liquid, is introduced via a print head, which is guided in a meandering manner over the coated first component, selectively according to the data of the respective layer image with a previously defined introduction based on the weight of the particulate material.

The printing liquid consists largely of water glass, a solvent (solvent) and possibly other liquid components, soluble, dispersible, and/or emulsifiable. The solvent is preferably water.

In order that water can be processed in a printing-stable manner, on the one hand the surface tension is reduced from approximately 72 mN/m to preferably below 40 mN/m, particularly preferably between 30 mN/m and 35 mN/m by adding a surfactant. Only small amounts are added for this purpose, as large amounts promote foam formation and can lead to nozzle failures during printing. For this reason, only amounts of up to 1% of a surfactant such as sodium dodecyl sulfate, sugar surfactants, SURFYNOL® 440, SURFYNOL® 465, or CARBOWET® 104 are added to the printing liquid.

The occurrence of foam is reduced by adding defoamers, for example from the group of siloxanes such as TEGO® FOAMEX 1488, and usually up to 0.5% of the printing liquid is added.

The water glasses used have a viscosity at room temperature that is too high for metering, which is adjusted to a printable range of 4 mPas-20 mPas by adding water.

After printing the layer, the construction platform is moved relative to the printing unit by a layer thickness and new powder material is applied.

An infrared lamp, which is located on the recoater axis and/or has a separate axis and/or is mounted on the print head axis, can heat the printed and/or the freshly applied layer by way of one or more passes. The increased temperature assists in reducing the amount of liquid again by evaporation. In addition to increasing the strength of the components, the heating step advantageously also produces greater contour sharpness, since the diffusion of the binder is reduced by the processes mentioned.

The surface temperature during the process is between 20° C. and 60° C.

After the construction process has been completed, 3 mm-30 mm, preferably 10 mm of empty layers are applied in order to fully embed the last built components in loose material.

After a waiting period of 4 hours to 24 hours, which depends on the height of the job, the component can be freed of loose material, for example using a vacuum cleaner. The unbound powder can be fed back into the process after a control sieving.

The waiting time can be shortened by means of flowing air through the powder bed. For this purpose, the job box is equipped with a perforated base on or instead of the construction platform. The holes are selected so that the particulate material preferably does not penetrate. There is an air distribution chamber under the perforated base to which a negative pressure generator is connected in flow-through operation. A negative pressure is distributed over the entire construction platform via the air distribution chamber and the perforated base and results in a flow of air through the powder bed. The air dries the binder and removes the liquid in the direction of the negative pressure generator.

With an applied negative pressure of 0.23 bar, a sufficient air flow of 60 m³/h can thus be generated. The waiting time is shortened from 10 to 6 hours with a construction height of 500 mm.

After coarse sand removal, the components are then freed of any remaining material that still adheres using compressed air. The strengths of 80 N/cm²-180 N/cm² are rather weak in comparison to organically bound sand, but they are strong enough to be handled without being destroyed or deformed.

Since the 3D printed molding bodies have a porous surface, it is usually advantageous to treat the surface of the printed component before using it as a casting or laminating mold. The porosity at the interface is reduced to such an extent that in the further application step the surface of the printed material is no longer penetrated and the cast or laminate can be delimited from the printed component. The constructed mold is assembled or also placed in conventionally produced external molds and embedded using a resin such as epoxy, polyurethane, or polyester resin. Furthermore, silicones or hydraulically setting material systems can also be used. In addition, laminates based on glass or carbon fibers can be produced by means of the component surfaces.

After the material systems have hardened, demolding takes place either by breaking out the mold by means of the action of mechanical forces or by bringing solvent, preferably water, into contact with the mold. This can be done, for example, by dipping or dousing. The soluble component now dissolves quickly, wherein the cohesion of the insoluble powder is broken.

The insoluble component is also flushed out, can be collected, remixed with soluble material, and returned to the process. To release the constructed part, a sufficiently large gap is sufficient from which the insoluble material can flow out together with the solvent.

Some terms of the invention are explained in more detail below.

In the sense of the disclosure, “layering construction method” or “3D printing method” or “3D method” or “3D printing” means all method known from the prior art which enable the construction of components in three-dimensional forms and which are compatible with the method components and devices described hereinafter.

“Binder jetting” in the sense of the disclosure is to be understood as meaning that powder is applied to a construction platform in layers, the cross sections of the component are each printed on this powder layer using one or more liquids, and the position of the build platform is changed by one layer thickness in relation to the last position and these steps are repeated until the component is finished. Binder jetting here is also to be understood as layer construction methods that require an additional method component such as layer-by-layer exposure, for example using IR or UV radiation.

In the sense of the disclosure, “3D molding part”, “molding body”, or “component” or “molding part” means all three-dimensional objects produced by means of the method according to the invention and/or the device according to the invention which have a form stability.

“Construction space” is the geometric location in which the particulate material bed grows during the construction process by repeated coating using particulate material or through which the bed passes under continuous principles. In general, the construction space is delimited by a base, the construction platform, walls, and an open cover area, the construction level. With continuous principles there is usually a conveyor belt and delimiting side walls. The construction space can also be embodied by a so-called job box, which represents a unit that can be moved in and out of the device and allows batch production, wherein a job box is moved out after the process has been completed and a new job box can be moved into the device immediately, so that the production volume and thus the device performance is increased.

The “particulate material application” is the process by which a defined layer of powder is produced. This can be done either on the construction platform (construction field) or on an inclined plane relative to a conveyor belt with continuous principles. The particulate material application is also called “coating” or “recoating”.

In the sense of the disclosure, “selective liquid application” or “selective binder application” or “selective printing liquid application” can take place after each particulate material application or, depending on the requirements of the molding body and in order to optimize the molding body production, can also be done irregularly, for example several times in relation to one particulate material application. A sectional image through the desired body is imprinted.

Any known 3D printing device containing the required components may be used as a “device” for performing a method according to the disclosure. Typical components include coaters, construction field, means for moving the construction field or other components in continuous processes, job box, metering devices, and heating and irradiation means and other components known to those skilled in the art, which are therefore not explained in more detail here.

The construction material according to the disclosure is always applied in a “defined layer” or “layer thickness”, which is set individually according to the construction material and method conditions. It is, for example, 0.05 to 5 mm, preferably 0.07 to 2 mm.

A “coater” or “recoater” in the sense of the disclosure is a device part that can receive fluid, for example, particulate material, such as mineral or metallic materials or plastics, wood in the form of particles, or mixtures thereof, and transfers or applies it in layers in a controlled manner to a construction platform of a 3D device. The coater can be made elongated and the particulate material is located in a storage container above an outlet opening. The coater can also consist of a stationary blade or a counter-rotating roller, which spreads a certain amount of powder onto the construction field in front of the blade or roller.

A “storage container” in the sense of the disclosure is to be understood as the component of a coater into which the particulate material is filled and dispensed and applied to the construction platform of the 3D device via an outlet opening.

A “coater blade” in the sense of the disclosure is a substantially flat metallic component or a component manufactured from another suitable material, which is located at the outlet of the coater and via which the fluid is dispensed on the construction platform and smoothly painted. A coater may have one or two or more coater blades. A coater blade can be an oscillating blade that oscillates in the sense of a rotational movement when excited. Furthermore, this oscillation can be turned on and off by a means for generating oscillations. Depending on the arrangement of the outlet opening, the coater blade in the sense of the disclosure is arranged “substantially horizontal” or “substantially vertical”.

“Heating means” in the sense of the disclosure are means used to heat the particulate material to a desired temperature. A heating means can be any known heating unit that is compatible with the other device parts and is known to those skilled in the art and therefore does not need to be described in more detail here.

“3D printer” or “printer” or “3D printing device” in the sense of disclosure means the device in which a 3D printing method can take place. A 3D printer in the sense of the disclosure has an application means for construction material, for example a fluid such as a particulate material, and a solidification unit, for example a print head or an energy input means such as a laser or a heat lamp. Other machine components known to those skilled in the art and components known in 3D printing are combined with the machine components mentioned above depending on the special requirements in the individual case.

“Construction field” is the plane or, in an expanded sense, the geometric location on or in which a particulate material bed grows during the construction process due to repeated coating with particulate material. Often the construction field is delimited by a base, the “construction platform”, by walls and an open cover area, the construction level.

The process of “printing” or “3D printing” or “3D printing method” as defined in the disclosure refers to the combination of the processes material application, selective solidification, or also printing and working height adjustment and takes place in an open or closed process space.

A “receiving plane” in the meaning of the disclosure is to be understood as the plane to which the construction material is applied. According to the disclosure, the receiving plane is always freely accessible in one spatial direction by a linear movement.

“Construction field tool” or “functional unit” in the sense of disclosure are all means or devices used for fluid dispensing, for example, particulate material, and selective solidification in the production of molding parts. All material application means and layer treatment means are thus also construction field tools or functional units.

“Spreading” or “applying” in the sense of the disclosure means any manner in which the particulate material is distributed. For example, at the starting position of a coating pass, a larger amount of powder can be presented and distributed or spread into the layer volume by a blade or a rotating roller.

The “excess amount” or “overfeed” is the amount of particulate material that is pushed down in front of the coater during the coating pass at the end of the construction field.

The “print head” or “means of selective solidification” in the sense of the disclosure is usually composed of different components. These can be printing modules, among other things. The printing modules have a variety of nozzles from which the “printing liquid” and the “binder” in droplet form is expelled in a controlled manner onto the construction field. The print modules are aligned relative to the print head. The print head is aligned relative to the machine. This means that the position of a nozzle can be assigned to the machine coordinate system. The plane in which the nozzles are located is usually referred to as the nozzle plate.

In the meaning of the invention, “selective printing liquid application” may be carried after each particulate material or particulate material application or may be carried out irregularly, depending on the requirements of the molding body and in order to optimize the molding body production, i.e., not linearly and in parallel after each particulate material application. “Selective printing liquid application,” can thus be adjusted individually and during the molding body production.

A “printing liquid” or “binder” in the sense of the invention is used to be applied selectively to the particulate material applied and selectively achieve the formation of a component. The printing liquid can include or essentially consist of binder materials. A “printing liquid” in the sense of the invention comprises or consists of a liquid selected from the group consisting of water glass or an aqueous solution and a water glass. “Binder” in the sense of the invention are materials that undergo a phase change from liquid to solid in the process, for example by means of polymerisation or drying, and at the same time the part remaining in the powder bed bonds the previously wetted particles to one another. Or which has the result by means of dissolving by a solution or a solvent, for example an aqueous solvent, that solid and insoluble particles, for example sands, stick together in a particulate material and create a relative strength between the particles. The binder represents a component of the printing liquid, is comprised by it or can also be used synonymously with the term printing liquid in a certain context.

All flowable materials known for 3D printing can be used as “particulate material” or “powder” or “powder bed” in the sense of the disclosure, in particular in powder form, as a slip, or as a liquid. These can be, for example, sand, ceramic powder, glass powder, and other powders made from inorganic or organic materials such as metal powder, plastics, wood particles, fiber materials, cellulose, and/or lactose powder, as well as other types of organic, powdery materials. The particulate material is preferably a dry, free-flowing powder, but a cohesive cut-resistant powder can also be used. This cohesiveness can also be achieved by adding a binder material or an auxiliary material such as a liquid. The addition of a liquid can result in the particulate material being able to flow freely in the form of a slurry. In general, particulate material can also be referred to as fluids in the sense of the disclosure.

Depending on the application and the required surface quality, different average grain sizes of insoluble particulate material and soluble polymer are used. For high surface qualities, for example: sands having an average grain diameter of 60 μm-90 μm are used, wherein the layer height of 150 μm can be selected very finely. Coarser particles having, for example, a d50 =140 μm-250 μm only allow layer heights of 250 μm-400 μm. This results in coarser surfaces. The buildup speed is also influenced by the fineness of the particulate material.

In the present application, particulate material and powder are used synonymously.

A “material system” in the sense of invention consists of various components which, in their interaction, allow the layered construction of molding parts; these different components can be applied and dispensed in layers together or in succession.

In the sense of this invention, “casting material” is any castable material, in particular metals such as light metals, iron materials, or steel materials. Moreover, this is also understood to include materials that can be cast at room temperature or at slightly elevated temperatures.

The “porosity” is, in the sense of invention, a labyrinth structure of cavities that arises between the particles bonded in the 3D printing method.

The “sealing” acts on the geometric boundary between the printed mold and the cavity to be filled. It superficially closes the pores of the porous molded body.

“Cold casting methods” are to be understood in particular as casting methods in which the temperature of the casting mold and the core does not reach the decomposition or softening temperature of the mold material before, during, and after the casting. The strength of the mold is not influenced by the casting. The opposite would be metal casting methods in which the mold is generally slowly destroyed by the hot casting compound.

The term “treated surface” refers to a surface of the casting mold, which is treated in a preferably separate step after printing and cleaning the mold. This treatment often involves applying a material to the surface and thus also to the areas of the mold or core near the surface. All conceivable different methods can be considered for the application.

The treated surface can, for example, prevent castable material systems or liquid binders from penetrating the molded body due to hydrostatic pressure or capillary effects.

In particular for more complex molds, it is economically desirable to produce casting molds and cores for metal casting as well as for cold casting and laminating molds via 3D printed molds. Further embodiments and/or aspects of the invention are represented hereinafter.

Furthermore, the invention relates to the production of molds and cores by means of powder bed-based 3D printing in the layer construction process and using a liquid component that is selectively introduced into the particulate material.

In a further aspect, the invention relates to a use of the molds and cores according to the invention for producing metal castings and cold-cast castings as a lost casting mold or laminate.

In particular, the casting molds according to the invention can be used to produce concrete castings and/or cold-cast polymer components.

A powder bed-based 3D printing method is preferably used for the layer construction method.

If the surface is optionally additionally sealed using a hydrophobic material, the penetration of the casting material into the pores of the casting mold can be restricted well.

Furthermore, it is possible to change the porosity of the surface by way of a slurry and/or dispersion, in particular a slurry based on zirconium oxide, aluminum oxide, calcium oxide, titanium oxide, chalk, or silica and/or a solution based on plastic, cellulose, sugar, flour, and/or salt.

In addition, the porosity of the surface can be changed or sealed by a fat, oil, wax, and/or warm water-soluble substances.

### Exemplary Embodiments

A. An exemplary device for producing a molding part according to the present invention includes a powder coater. This is used to apply and smooth particulate material on a construction platform. In this specific application, a VX1000 3D printer is used. The applied particulate material can consist of a wide variety of materials, but quartz sand is preferred according to the invention and due to its low cost. In this specific case, GS14 sand from Strobel Quarzsande is used, which has an average grain size of 140 μm. The sand is mixed with a powdered promoter before processing in the 3D printer. A suitable promoter is, for example, EP4500 from ASK Chemicals in Hilden. 0.2% by weight of this is mixed into the sand. The promoter causes a higher heat resistance of the casting core or mold. In addition, an ester is mixed into the sand as a liquid activator at a rate of 0.25% by weight. The mixing is advantageously carried out in a compulsory mixer. The material mixture can be fed to the 3D printer directly after preparation. The height of the powder layers is determined by the construction platform. It is lowered after applying a layer. During the next coating process, the resulting volume is filled and the excess is smoothed out. The result is an essentially or even almost perfectly parallel and smooth layer of defined height. In this specific case, the construction platform is lowered by 0.3 mm each time.

After a coating process, the layer is printed using the printing liquid by means of an inkjet print head. The printing liquid is a liquid mixture that contains water glass as an essential component. A suitable printing liquid is, for example, EP5061 from ASK CHEMICALS from HILDEN (GERMANY). A printing liquid content of 3.5% by weight is metered into the printed area for this purpose. The printed image corresponds to the section through the component at the current structural height of the device. The liquid hits the particulate material and slowly diffuses therein.

The printing liquid physically bonds the surrounding loose particles with one another. The bond is initially only of low strength.

In the next step, the construction platform is lowered by one layer thickness. The steps of layer formation, printing, and lowering are now repeated until the desired component is completely created.

The component is now completely in the powder cake and has to continue to harden. At room temperature, this step can take up to several hours depending on the height constructed. In this specific case, the job box having a structural height of 300 mm has to rest outside the machine for 20 hours at room temperature.

Alternatively, negative pressure can be applied to the box for 3 hours, wherein ambient air is drawn through the powder cake and the components are dried in the process.

In the next step, the component is freed from loose particulate material. In addition, loose powder material can then be cleaned using, for example, compressed air.

After unpacking and finishing, bending samples aligned in the construction plane have a 3-point bending strength in the range of 150 to 180 N/cm² and a residual moisture of 0.3% by weight. At a maximum relative ambient humidity of 60%, the molding parts produced using the 3D printing method disclosed here can be stored without deformation.

The remaining loose sand can be used again immediately after a control sieving. Due to the reduction in the effect of the ester activator over time, it is advantageous to add freshly mixed sand to the remaining sand in a fixed mixing ratio and to use this mixture again in a 3D printing method.

C. The produced component (molding part) can then be dried in the oven to further increase its strength and can then be used for metal casting.

Further treatment of the surface of the molding parts produced using the 3D printing method disclosed here is advantageous with metal alloys such as iron or steel or also for use in cold casting or as a laminating mold.

What is claimed is:

1. A material system suitable for a 3D printing method or 3D printing method material system comprising or consisting of a particulate material, a printing liquid, and an ester activator.

2. The material system according to claim 1, wherein the particulate material is selected from the group consisting of at least one inorganic particulate material and/or at least one organic particulate material, wherein the inorganic particulate material is preferably a quartz sand, an olivine sand, a kerphalite, a Cerabeads, a ceramic, and/or a metal powder and the organic particulate material is preferably a wood powder, a starch powder, and/or a cellulose powder and the printing liquid comprises or consists of a liquid selected from the group consisting of water glass or an aqueous solution comprising water glass, and the ester activator consists of or comprises one or more condensates of monovalent or polyvalent alcohols and monovalent or polyvalent organic carboxylic acids, such as formic and/or acetic acid, or dimethyl adipate, diethyl glutarate, triacetin, dimethyl succinate, or mixtures of various esters, preferably having a vapor pressure <1 hPa, preferably
wherein the particulate material is mixed with an ester activator and optionally with a solid promoter, preferably
wherein the ester activator is mixed into the particulate material with an addition of 0.2-1% by volume, preferably
wherein the particulate material has an average grain size of 0.02-0.5 mm, preferably
wherein the ratio of printing liquid to ester activator is between 8 and 12, preferably
wherein the printing liquid also comprises surfactants, such as sodium dodecyl sulfate or Surfynol 465 and has the surface tension of 20 mN/m-50 mN/m, preferably 25 mN/m-40 mN/m, and particularly preferably of 28 mN/m-35 mN/m, and/or comprises defoamer from, for example, the group of siloxanes and/or comprises colorants and/or alkali metal hydroxides for adjusting the pH value.

3. A 3D printing method for producing a molding body comprising the steps of applying a particulate material mixture to a construction level, selectively applying a printing liquid, wherein the printing liquid comprises or consists of a liquid selected from the group consisting of water or a aqueous solution and a water glass-containing component or derivatives thereof for at least partial selective solidification, optionally controlling the temperature of the construction field or energy input into the applied particulate material mixture, preferably controlling the temperature to 20° C. to 60° C., and the printing liquid, repeating these steps until the desired molding part was obtained, preferably
wherein the printing liquid is metered into the particulate material with an addition of 2-10% by volume.

4. The 3D printing method according to claim 3, wherein the obtained molding part is separated from the unsolidified particulate material and the molding part is preferably subjected to a further heat treatment step and/or a treatment using microwave radiation and/or
wherein the particulate material is applied using a coater (recoater) and/or
wherein the printing liquid is selectively applied using a print head and/or
wherein the molding part is left in a powder bed at ambient conditions for 1 hour-24 hours after completion of the printing method.

5. The 3D printing method of claim 3, wherein the molding part is dried and/or hardened by suctioning a gas or gas mixture, preferably ambient air, through the entirety of non-printed and printed areas after the printing method has been completed, wherein preferably this suctioning through takes place 0 h-24 h, preferably 0 h-12 h, particularly preferably directly after the end of printing, preferably suctioning through takes place for 0.5 to 5 hours and preferably the molding part has a strength of 150 N/cm2 to 200 N/cm2.

6. The 3D printing method of claim 3,
wherein, in an additional step, the molding part is subjected to a treatment using microwave radiation, wherein preferably the treatment takes place over a period of time of 2 minutes-30 minutes, preferably 2 minutes-15 minutes, particularly preferably 2 minutes-10 minutes, and/or wherein the surface of the molding part is furthermore coated or sealed.

7. The 3D printing method of claim 3, wherein a material system comprising or consisting of a particulate material, a printing liquid, and an ester activator.

8. A molding part produced with 3D printing method according to claim 3, preferably wherein the residual moisture in the printed molding part is 0.3-1.0% by weight and/or the molding part has strengths of 80 N/cm2-150 N/cm2, preferably 200 N/cm2, in the printing direction.

9. The 3D printing method of claim 3, wherein the molding part is left for 4 hours-24 hours, preferably 8 hours-15 hours, particularly preferably 10 hours-11 hours, at ambient conditions in the powder bed.

10. The method of claim 3, wherein the molding part is a metal casting mold, a cold casting mold, or a laminating mold.

11. The method of claim 3, wherein the particulate material comprises:
i) a quartz sand, an olivine sand, a kerphalite, a Cerabeads, a ceramic, or a metal powder; where and the organic particulate material is preferably a wood powder, a starch powder, and
ii) 0.2% to 1% by volume of an ester activator.

12. The method of claim 11, wherein the particulate material includes a solid promoter.

13. The method of claim 11, wherein the ester activator comprises one or more condensates of monovalent or polyvalent alcohols and monovalent or polyvalent organic carboxylic acids, such as formic and/or acetic acid, or dimethyl adipate, diethyl glutarate, triacetin, dimethyl succinate, or mixtures of various esters.

14. The method of claim 13, wherein the printing liquid comprises water glass.

15. The method of claim 14, wherein
the particulate material has an average grain size of 0.02-0.5 mm;
a ratio of printing liquid to ester activator is between 8 and 12;
the printing liquid comprises a surfactant, or a defoamer.

16. The method of claim 14, wherein the printing liquid comprises an alkali metal hydroxide.

17. The method of claim 11, wherein
the method includes controlling the temperature of the construction field to 20° C. to 60° C., and the printing liquid,
wherein the printing liquid is metered into the particulate material with an addition of 2-10% by volume.

18. The method of claim 17, wherein
the obtained molding part is separated from the unsolidified particulate material and the molding part is preferably subjected to a further heat treatment step and/or a treatment using microwave radiation; and
the particulate material is applied using a coater; and
the printing liquid is selectively applied using a print head; and
the molding part is left in a powder bed at ambient conditions for 1 hour-24 hours after completion of the printing method.

19. The method of claim 17, wherein the method includes
drying or hardening the molding part by suctioning a gas or gas mixture, preferably ambient air, through the entirety of non-printed and printed areas after the printing method has been completed for 0.5 to 5 hours.

20. The method of claim 19, wherein, the molding part, after drying and/or hardening, the method includes subjecting the molded part to a treatment using microwave radiation, for 2 minutes-30 minutes.
